(19) United States
(12) Patent Application Publication
(10) Pub. No.: US 2013/0010498 A1
(43) Pub. Date: Jan. 10, 2013

(54) LIGHT GUIDE PLATE AND A BACKLIGHT DISPLAY MODULE

(75) Inventors: Yajun Yu, Shenzhen (CN); Yicheng Kuo, Shenzhen (CN); Lifeng Wang, Shenzhen (CN)

(73) Assignee: Shenzhen China Star Optoelectronics, Shenzhen (CN)

(21) Appl. No.: 13/378,047

(22) PCT Filed: Oct. 18, 2011
(86) PCT No.: PCT/CN2011/080907

§ 371 Date: Dec. 14, 2011

(30) Foreign Application Priority Data
Jul. 6, 2011 (CN) 201120235959.5

(51) Int. Cl. G02B 6/00

(52) U.S. Cl. 362/616

(57) ABSTRACT

The present invention provides a light guide plate. The light guide plate comprises at least two daughter light guide plates and a connection member. Each daughter light guide plate disposes two locating posts respectively on two sides thereof, which can be engaged with the connection member to make the two daughter light guide plates be interconnected so that forming one large area light guide plate. The present invention also relates to a backlight display module. The light guide plate and the backlight module of the present invention has a less manufacture difficulty and a low transportation cost and can realize the use of the large area light guide plate, so that avoiding the problems of the large area light guide plate being difficult to be manufactured and having the high transportation cost in the prior art.

### BACKGROUND OF THE INVENTION

1. Field of the Invention

The present invention relates to a light guide plate and a backlight display module, and more particularly to a variable-sized and modularized light guide plate and a backlight display module.

2. Description of the Prior Art

With the development of the society, a large-sized liquid crystal display becomes more and more popular because it can create a more realistic effect. But during the manufacture of a backlight module of the large-sized liquid crystal display, a large area light guide plate is difficult to be manufactured. The whole light guide plate is often abandoned or become a defective product because of the flaws existing in some areas of the light guide plate, so that resulting in the high manufacturing cost of the large area light guide plate. And because the large area light guide plate is very inconvenient to be transported, so that resulting in the transporting cost increasing.

Hence, it is needed to provide a light guide plate and a backlight display module to solve the problem existing in the prior art.

### BRIEF SUMMARY OF THE INVENTION

The present invention provides a light guide plate to solve the problem of the large area light guide plate having the high manufacturing cost and the high transporting cost.

An object of the present invention is to provide a backlight display module to solve the problem of the large area light guide plate having the high manufacturing cost and the high transporting cost in the backlight display module.

The present invention is realized in such a way that:

A light guide plate comprises at least two daughter light guide plates and a connection member. Each daughter light guide plate disposes two locating posts respectively on two sides thereof, which can be engaged with the connection member to make the two daughter light guide plates be interconnected so that forming one large area light guide plate. The connection member disposes at least two opening portions used to be respectively connected to the locating posts of the two daughter light guide plates. Each locating post includes a protruding portion and an extending portion. The area of the extending portion is greater than that of the protruding portion so that forming a holding groove on the protruding portion. The opening portions are engaged with the holding grooves for making the two daughter light guide plates be interconnected. The sectional area of each opening portion is greater than that of the corresponding protruding portion and smaller than that of the corresponding extending portion. The section of the opening portion is arc, triangular, quadrate or polygonal. The section of the protruding portion is circular, triangular, quadrate or polygonal. The section of the extending portion is circular, triangular, quadrate or polygonal. The opening portions disposed on the connection member are same or different for being connected to the locating posts.

A light guide plate comprises at least two daughter light guide plates and a connection member. Each daughter light guide plate disposes two locating posts respectively on two sides thereof, which can be engaged with the connection member to make the two daughter light guide plates be interconnected so that forming one large area light guide plate.

The present invention also provides a backlight display module. The backlight display module comprises a light guide plate. The light guide plate comprises at least two daughter light guide plates and a connection member. Each daughter light guide plate disposes two locating posts respectively on two sides thereof, which can be engaged with the connection member to make the two daughter light guide plates be interconnected so that forming one large area light guide plate.

In one embodiment of the present invention, the connection member disposes at least two opening portions used to be respectively connected to the locating posts on the two daughter light guide plates.

In one embodiment of the present invention, each locating post includes a protruding portion and an extending portion, and the area of the extending portion is greater than that of the protruding portion so that forming a holding groove on the protruding portion.

In one embodiment of the present invention, the opening portions are engaged with the holding grooves for making the two daughter light guide plates be interconnected, and the sectional area of each opening portion is greater than that of the corresponding protruding portion and smaller than that of the corresponding extending portion.

In one embodiment of the present invention, the section of the opening portion is arc, triangular, quadrate or polygonal.

In one embodiment of the present invention, the section of the protruding portion is circular, triangular, quadrate or polygonal.

In one embodiment of the present invention, the section of the extending portion is circular, triangular, quadrate or polygonal.

In one embodiment of the present invention, the two opening portions disposed on the connection member are same for being connected to the locating posts.

In one embodiment of the present invention, the two opening portions disposed on the connection member are different for being connected to the locating posts.

Comparing with the prior light guide plate and the backlight display module being difficult to be manufactured and having the high transporting cost, the light guide plate and the backlight display module in the present invention employ the connection member to connect the daughter light guide plates for forming one large area light guide plate. Because the area of the daughter light guide plate is small, the daughter light guide plate has a less manufacture difficulty and a low transportation cost, so that avoiding the above problems of the prior light guide plate and the backlight display module.

For more clearly and easily understanding above content of the present invention, the following text will take a preferred embodiment of the present invention with reference to the accompanying drawings for detail description as follows.

### BRIEF DESCRIPTION OF THE DRAWINGS

FIG. 1 is a structural schematic view of a light guide plate mounted with a connection member in one preferred embodiment of the present invention;

FIG. 2 is a structural schematic view of the connection member of the light guide plate in one preferred embodiment of the present invention; and

FIG. 3 is a structural schematic view of the light guide plate being no mounted with the connection member in one preferred embodiment of the present invention.

### DETAILED DESCRIPTION OF THE PREFERRED EMBODIMENTS

The following description of every embodiment with reference to the accompanying drawings is used to exemplify a specific embodiment, which may be carried out in the present invention. Directional terms mentioned in the present invention, such as “top”, “bottom”, “front”, “back”, “left”, “right”, “inside”, “outside”, “side” etc., are only used with reference to the orientation of the accompanying drawings. Therefore, the used directional terms are intended to illustrate, but not to limit, the present invention.

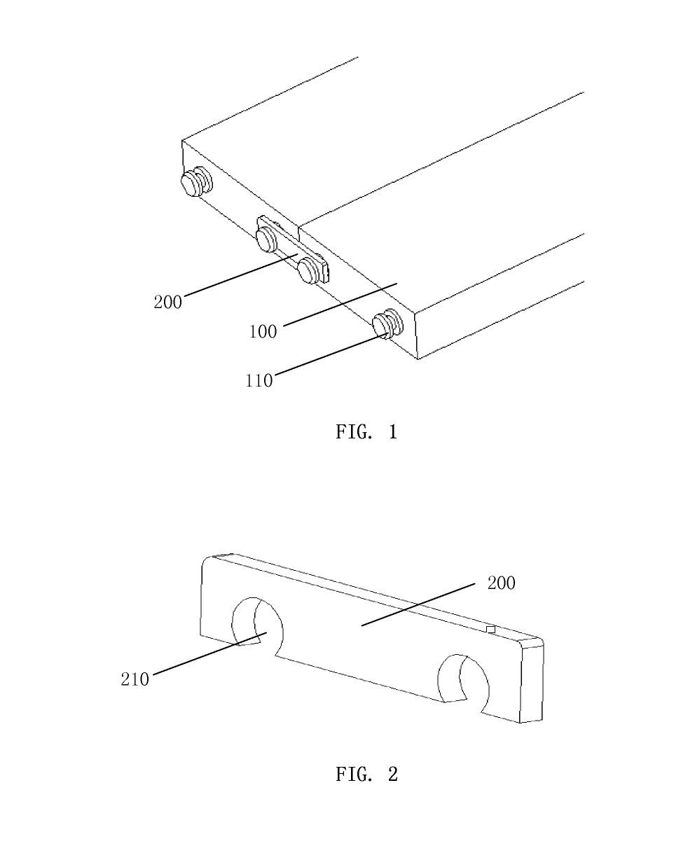

In a structural schematic view of FIG. 1, which shows a light guide plate mounted with a connection member in one preferred embodiment of the present invention, the light guide plate comprises at least two daughter light guide plates 100 and a connection member 200. Each daughter light guide plate 100 disposes two locating posts 110 respectively on two sides thereof, which can be engaged with the connection member to make the two daughter light guide plates 100 be interconnected so that forming one large area light guide plate.

The light guide plate of the present invention comprises a plurality of the daughter light guide plates 100. The light exit areas of the daughter light guide plates 100 may be same, but also may be different. Each daughter light guide plate 100 disposes the locating posts 110 on the sides thereof. The connection member 200 is fixedly connected to the locating posts 110 so that the daughter light guide plates 100 can be orderly interconnected to form one large area light guide plate, thereby realizing a large-sized liquid crystal display. When needing to pack and transport the light guide plate of the present invention, the connection member may be removed so that the daughter light guide plates 100 can overlap each other according to the needed shape or be separately transported, thereby reducing the difficulty and cost of the transportation. Moreover, if some daughter light guide plate 100 has the quality problem or flaw, there need not replace all the daughter light guide plates 100, but only need pick out the daughter light guide plate 100 having the flaw to replace it for overcoming the quality problem, so that reducing the defective rate of the large area light guide plate and reducing the manufacture cost.

In a structural schematic view of FIG. 2, which shows the connection member of the light guide plate in one preferred embodiment of the present invention, the connection member 200 disposes at least two opening portions 210 used to be respectively connected to the locating posts 110.

The light guide plate of the present invention can realize the interconnection of the daughter light guide plates 100 by the engagement of the opening portions 210 of the connection member 200 and the locating posts 110 of the daughter light guide plates 100. The position and number of the opening portions 210 of the connection member 200 may be determined according to the size of each daughter light guide plate 100 (particularly according to the position of the locating posts 110). If the sizes (namely the light exit areas) of all the daughter light guide plates 100 are same, the connection member 200 generally disposes two opening portions 210 to connect two daughter light guide plates 100. But if the sizes of the daughter light guide plates 100 are different, the connection member 200 needs to dispose multiple opening portions 210 to be adapted for connecting the daughter light guide plates 100 having different sizes.

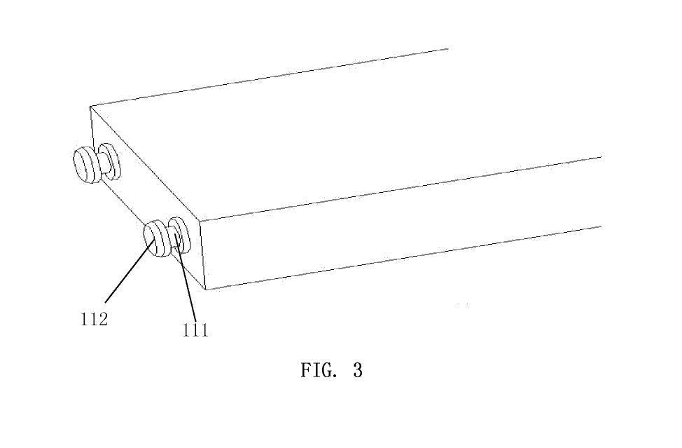

FIG. 3 is a structural schematic view of the light guide plate being no mounted with the connection member in one preferred embodiment of the present invention. The locating post 110 includes a protruding portion 111 and an extending portion 112. The area of the extending portion 112 is greater than that of the protruding portion 111, so there forms a holding groove on the protruding portion 111. The opening portion 210 can be engaged with the holding groove for making the daughter light guide plates 100 be interconnected. The sectional area of the opening portion 210 is greater than that of the protruding portion 111, and is smaller than that of the extending portion 112.

In order to make the opening portion 210 be better connected to the locating post 110, the locating post 110 disposes a protruding portion 111 and an extending portion 112 to form a holding groove as shown in FIG. 3 on the protruding portion 11. The opening portion 210 is fitted on the holding groove for interconnecting the daughter light guide plates 100. The sectional area of the opening portion 210 is greater than that of the protruding portion 111, and is smaller than that of the extending portion 112, so that the opening portion 210 may conveniently clamp the holding groove. Moreover, the connection member 200 is not easy to escape after being locked on the locating post 110 and the connection member 200 may adopt different hard materials according to the user demand.

To be one preferred embodiment of the present invention, the section of the opening portion 210 may be arc, triangular, quadrate or polygonal. The section of the protruding portion 111 may be circular, triangular, quadrate or polygonal. The section of the extending portion 112 may be circular, triangular, quadrate or polygonal.

The section of the opening portion 210 may be various shapes, such as an arc, triangular, quadrate or polygonal shape. The user may adopt the opening portion 210 having any fitted shaped section, which is identical with the shape of the section of the protruding portion 111 for the convenience of the engagement of the opening portion 210 and the holding groove. Therefore, the shape of the section of the protruding portion 111 may be circular, triangular, quadrate or various polygonal. Moreover, for preventing the connection member 200 from escaping from the locating post 110, the extending portion 112 also may be disposed to be various shapes, such as a circular, triangular, quadrate or various polygonal shapes, which can make the opening portion 210 be better fixed in the holding groove.

To be one preferred embodiment of the present invention, the connection member 200 disposes multiple opening portions 210 having a same shape and used to be connected to the locating portion 110. When the sizes of the daughter light guide plates 100 are different, the connection member 200 may dispose multiple opening portions 210, the shapes of which are respectively same as those of the protruding portions 111 of the locating posts 110 on the daughter light guide plates 100 for being adapted for the different distances from the locating posts 110 of different daughter light guide plates 100 to the edges of the different daughter light guide plates 100. Accordingly, the same connection member 200 may be adapted for the connection between various different daughter light guide plates 100, so that being convenient for the user to use.

To be one preferred embodiment of the present invention, the connection member 200 disposes multiple opening portions 210 having different shapes and used to be connected to the locating portion 110. When different daughter light guide plates 100 employ the different protruding portions 111 of the locating posts 110, the connection member 200 may dispose multiple opening portions 210, the shapes of which are respectively same as those of the protruding portions 111 of the locating posts 110 on the daughter light guide plates 100 for being adapted for the different distances from the locating posts 110 of different daughter light guide plates 100 to the edges of the different daughter light guide plates 100. Accordingly, different protruding portions 111 can be used to distinguish the different daughter light guide plates 100. When concretely implementing, because the connection member 200 disposes multiple opening portion 210 having different shapes, the same connection member 200 can realize the connection between various different daughter light guide plates 100, so that not only being convenient for the user to distinguish different daughter light guide plates 100, but also being convenient for the user to use.

The present invention also relates to a backlight display module. The backlight display module comprises a light source and a light guide plate. The light guide plate comprises at least two daughter light guide plates 100 and a connection member 200. Each daughter light guide plate 100 disposes two locating posts 110 respectively on two sides thereof, which can be engaged with the connection member to make the two daughter light guide plates 100 be interconnected so that forming one large area light guide plate. The connection member 200 disposes at least two opening portions 210 used to be respectively connected to the locating posts 110. The locating post 110 includes a protruding portion 111 and an extending portion 112. The area of the extending portion 112 is greater than that of the protruding portion 111, so there forms a holding groove on the protruding portion 111. The opening portion 210 can be engaged with the holding groove for making the daughter light guide plates 100 be interconnected. The sectional area of the opening portion 210 is greater than that of the protruding portion 111, and is smaller than that of the extending portion 112. The section of the opening portion 210 may be arc, triangular, quadrate or polygonal. The section of the protruding portion 111 may be circular, triangular, quadrate or polygonal. The section of the extending portion 112 may be circular, triangular, quadrate or polygonal. The connection member 200 disposes multiple same and/or different opening portions 210 used to be connected to the locating posts 110. The beneficial effects and the implementation mode of the backlight display module of the present invention are similar to those of the abovementioned light guide plate, so the concrete context may refer to above embodiment of the light guide plate.

In conclusion, although the present invention has been disclosed by above preferred embodiments, above preferred embodiments are not used to limit the present invention. One of ordinary skills in the art also can make all sorts of improvements and amendments within the principles of the present invention. Therefore, the protection scope of the present invention should be based on the scope defined by the appended claims.

What is claimed is:

1. A light guide plate, characterized in that: the light guide plate comprising at least two daughter light guide plates and a connection member, each daughter light guide plate disposing two locating posts respectively on two sides thereof, which can be engaged with the connection member to make the two daughter light guide plates be interconnected so that forming one large area light guide plate; the connection member disposing at least two opening portions used to be respectively connected to the locating posts of the two daughter light guide plates; each locating post including a protruding portion and an extending portion; the area of the extending portion being greater than that of the protruding portion so that forming a holding groove on the protruding portion; the opening portions being engaged with the holding grooves for making the two daughter light guide plates be interconnected; the sectional area of each opening portion being greater than that of the corresponding protruding portion and being smaller than that of the corresponding extending portion; the section of the opening portion being arc, triangular, quadrate or polygonal; the section of the protruding portion being circular, triangular, quadrate or polygonal; the section of the extending portion being circular, triangular, quadrate or polygonal; the opening portions disposed on the connection member being same or different for being used to be connected to the locating posts.

2. A light guide plate, characterized in that: the light guide plate comprising at least two daughter light guide plates and a connection member, each daughter light guide plate disposing two locating posts respectively on two sides thereof, which can be engaged with the connection member to make the two daughter light guide plates be interconnected so that forming one large area light guide plate.

3. The light guide plate as claimed in claim 2, characterized in that: the connection member disposes at least two opening portions used to be respectively connected to the locating posts on the two daughter light guide plates.

4. The light guide plate as claimed in claim 3, characterized in that: each locating post includes a protruding portion and an extending portion, and the area of the extending portion is greater than that of the protruding portion so that forming a holding groove on the protruding portion.

5. The light guide plate as claimed in claim 4, characterized in that: the opening portions are engaged with the holding grooves for making the two daughter light guide plates be interconnected, and the sectional area of each opening portion is greater than that of the corresponding protruding portion and smaller than that of the corresponding extending portion.

6. The light guide plate as claimed in claim 3, characterized in that: the section of the opening portion is arc, triangular, quadrate or polygonal.

7. The light guide plate as claimed in claim 4, characterized in that: the section of the protruding portion is circular, triangular, quadrate or polygonal.

8. The light guide plate as claimed in claim 4, characterized in that: the section of the extending portion is circular, triangular, quadrate or polygonal.

9. The light guide plate as claimed in claim 3, characterized in that: the two opening portions disposed on the connection member are same for being used to be connected to the locating posts.

10. The light guide plate as claimed in claim 6, characterized in that: the two opening portions disposed on the connection member are different for being used to be connected to the locating posts.

11. A backlight display module, comprising the light guide plate, characterized in that: the light guide plate comprising at least two daughter light guide plates and a connection member, each daughter light guide plate disposing two locating posts respectively on two sides thereof, which can be engaged with the connection member to make the two daughter light guide plates be interconnected so that forming one large area light guide plate.

12. The backlight display module as claimed in claim 11, characterized in that:
the connection member disposes at least two opening portions used to be respectively connected to the locating posts on the two daughter light guide plates; each locating post includes a protruding portion and an extending portion, and the area of the extending portion is greater than that of the protruding portion so that forming a holding groove on the protruding portion; the opening portions are engaged with the holding grooves for making the two daughter light guide plates be interconnected, and the sectional area of each opening portion is greater than that of the corresponding protruding portion and smaller than that of the corresponding extending portion.

13. The backlight display module as claimed in claim 12, characterized in that:
the section of the opening portion is arc, triangular, quadrate or polygonal; the section of the protruding portion is circular, triangular, quadrate or polygonal; and the section of the extending portion is circular, triangular, quadrate or polygonal.

14. The backlight display module as claimed in claim 12, characterized in that:
the two opening portions disposed on the connection member are same for being used to be connected to the locating posts.

15. The backlight display module as claimed in claim 13, characterized in that:
the two opening portions disposed on the connection member are different for being used to be connected to the locating posts.
